(19) United States
(12) Patent Application Publication
(10) Pub. No.: US 2025/0095938 A1
(43) Pub. Date: Mar. 20, 2025

(54) ELECTROMAGNETIC RELAY

(71) Applicants: DENSO CORPORATION, Kariya-city (JP); DENSO ELECTRONICS CORPORATION, Anjo-city (JP)

(72) Inventors: Ryota KUNIYOSHI, Kariya-city (JP); Tomohiro YASUDA, Kariya-city (JP); Shingo KURITA, Kariya-city (JP); Takashi KAWASHIMA, Kariya-city (JP); Hiroshi NAGURA, Anjo-city (JP)

(73) Assignees: DENSO CORPORATION, Kariya-city (JP); DENSO ELECTRONICS CORPORATION, Anjo-city (JP)

(21) Appl. No.: 18/965,411

(22) Filed: Dec. 2, 2024

Related U.S. Application Data
(63) Continuation of application No. PCT/JP2023/018345, filed on May 16, 2023.

(30) Foreign Application Priority Data
May 30, 2022 (JP) 2022-087570

(51) Int. Cl. H01H 50/18; H01H 50/02; H01H 50/36

(52) U.S. Cl. CPC H01H 50/18; H01H 50/023; H01H 50/36

(57) ABSTRACT

An electromagnetic relay includes a sealed housing, a fixed contact, a movable element having a movable contact, a shaft, a movable core, a fixed core, a return spring, an electromagnetic coil and a sleeve. The shaft is slidably inserted in a through-hole formed in the fixed core. The sleeve has a support part supporting the movable core so as to define a position of the movable core relative to the fixed core when no magnetic attraction acts therebetween. At a front end of the sleeve, there is formed a position adjustment part for adjusting a positional relationship between the fixed core and the support part during the direct or indirect fixing of the sleeve to the fixed core.

### CROSS-REFERENCE TO RELATED APPLICATIONS

The present application is a continuation application of International Application No. PCT/JP2023/018345 filed on May 16, 2023, which is based on and claims priority from Japanese Patent Application No. 2022-087570 filed on May 30, 2022. The entire contents of these applications are incorporated by reference into the present application.

### BACKGROUND

### 1 Technical Field

The present disclosure relates to electromagnetic relays.

### 2 Description of Related Art

There are known electromagnetic relays in which a movable element is moved by magnetic attraction generated by energization of an electromagnetic coil, causing a fixed contact and a movable contact to be brought into contact with and separated from each other.

### SUMMARY

According to the present disclosure, there is provided an electromagnetic relay which includes: a sealed housing; a fixed contact arranged in the sealed housing; a movable element having a movable contact configured to be brought into contact with and separated from the fixed contact in the sealed housing; a shaft holding the movable element and provided in such a manner as to be capable of advancing and retreating in an axial direction relative to the sealed housing; a movable core fixed to the shaft; a fixed core fixed to the sealed housing; a return spring urging the movable contact in a direction away from the fixed contact; an electromagnetic coil configured to generate, when energized, magnetic attraction between the fixed core and the movable core; and a sleeve hermetically sealing the return spring and the movable core therein and fixed directly or indirectly to the fixed core. Moreover, in the electromagnetic relay, the shaft is slidably inserted in a through-hole formed in the fixed core. The sleeve has a support part supporting the movable core so as to define a position of the movable core relative to the fixed core when the magnetic attraction does not act. At a front end of the sleeve, there is formed a position adjustment part for adjusting a positional relationship between the fixed core and the support part during the direct or indirect fixing of the sleeve to the fixed core.

### BRIEF DESCRIPTION OF THE DRAWINGS

FIG. 1 is a cross-sectional explanatory diagram of an electromagnetic relay according to a first embodiment.

FIG. 2 is a cross-sectional view taken along the line II-II in FIG. 1.

FIG. 3 is a cross-sectional explanatory diagram of the electromagnetic relay according to the first embodiment, illustrating a contact abutting state in which the contact pressure is substantially zero.

FIG. 4 is a cross-sectional explanatory diagram of the electromagnetic relay according to the first embodiment, illustrating a state in which contact pressure acts.

FIG. 5 is an explanatory diagram illustrating a state before a shaft is inserted into a fixed core according to the first embodiment.

FIG. 6 is an explanatory diagram illustrating a process of covering a movable element with a sealed housing according to the first embodiment.

FIG. 7 is an explanatory diagram illustrating a state in which a movable contact is abutted against a fixed contact with the contact pressure being zero according to the first embodiment.

FIG. 8 is an explanatory diagram illustrating a process of assembling a movable core to the shaft with the contact pressure kept at zero according to the first embodiment.

FIG. 9 is an explanatory diagram illustrating a process of placing a sleeve to cover the movable core with the contact pressure kept at zero according to the first embodiment.

FIG. 10 is an explanatory diagram illustrating a process of advancing the sleeve together with the movable core while applying contact pressure according to the first embodiment.

FIG. 11 is an explanatory diagram illustrating a process of retreating the sleeve together with the movable core by a predetermined amount according to the first embodiment.

FIG. 12 is a cross-sectional explanatory diagram of an electromagnetic relay according to a second embodiment.

FIG. 13 is an enlarged cross-sectional explanatory diagram of a joint between a fixed core and a sleeve according to the second embodiment.

FIG. 14 is a cross-sectional explanatory diagram, taken along a plane perpendicular to a Z direction, of the fixed core according to the second embodiment.

FIG. 15 is a cross-sectional explanatory diagram, taken along a plane perpendicular to the Z direction, of the sleeve according to the second embodiment.

FIG. 16 is an enlarged cross-sectional explanatory diagram of a joint between a fixed core and a sleeve according to a third embodiment.

FIG. 17 is an explanatory diagram of the fixed core as seen from a rear side in the Z direction according to the third embodiment.

FIG. 18 is a cross-sectional explanatory diagram, taken along the line XVIII-XVIII in FIG. 16, of the sleeve according to the third embodiment.

FIG. 19 is a cross-sectional explanatory diagram of an electromagnetic relay according to a fourth embodiment.

FIG. 20 is an explanatory diagram illustrating a process of placing a sleeve to cover a movable core with the contact pressure kept at zero according to the fourth embodiment.

FIG. 21 is an explanatory diagram illustrating a process of advancing the sleeve together with the movable core while applying contact pressure according to the fourth embodiment.

FIG. 22 is an explanatory diagram illustrating a process of retreating the sleeve together with the movable core by a predetermined amount according to the fourth embodiment.

FIG. 23 is a cross-sectional explanatory diagram of an electromagnetic relay according to a fifth embodiment.

FIG. 24 is an explanatory diagram illustrating a state immediately before placing a sleeve to cover a movable core according to the fifth embodiment.

FIG. 25 is an explanatory diagram illustrating a process of placing the sleeve to cover the movable core with the contact pressure kept at zero according to the fifth embodiment.

FIG. 26 is an explanatory diagram illustrating a process of advancing the sleeve together with the movable core while applying contact pressure according to the fifth embodiment.

FIG. 27 is an explanatory diagram illustrating a process of retreating the sleeve together with the movable core by a predetermined amount according to the fifth embodiment.

FIG. 28 is a cross-sectional explanatory diagram of an electromagnetic relay according to a sixth embodiment.

FIG. 29 is an explanatory diagram illustrating a process of assembling a movable core to a shaft with the contact pressure kept at zero while adjusting an inter-core distance according to the sixth embodiment.

FIG. 30 is an explanatory diagram illustrating a state immediately before placing a sleeve to cover the movable core according to the sixth embodiment.

FIG. 31 is an explanatory diagram illustrating a process of advancing the sleeve with the movable core being supported by a support part according to the sixth embodiment.

FIG. 32 is an explanatory diagram illustrating a state in which the sleeve has been advanced together with the movable core until the inter-core distance reaches a predetermined distance according to the sixth embodiment.

### DESCRIPTION OF EMBODIMENTS

There is disclosed, for example in Japanese Patent Application Publication No. JP H09-259728 A, a sealed contact device. In the sealed contact device, in order to improve the separating performance between the fixed contact and the movable contact when the electromagnetic relay is turned off, the contacts are arranged within a space in which a gas, such as hydrogen, is hermetically sealed. Consequently, it becomes possible to facilitate extinguishing of arcs generated between the contacts, thereby improving the separating performance.

The sealed contact device disclosed in the above patent document is configured to be capable of adjusting the contact pressure under which the fixed contact and the movable contact are kept in contact with each other in an ON state of the electromagnetic relay. However, in the sealed contact device, it is difficult to adjust the distance between the contacts in an OFF state of the electromagnetic relay. In other words, it is difficult to accurately set the distance between the fixed contact and the movable contact in a non-energized state of the electromagnetic coil. If the distance between the fixed contact and the movable contact in the OFF state is set to be too short, it will become difficult to extinguish the arcs when it is required to turn off the electromagnetic relay; this is disadvantageous to the separating performance. In contrast, if the distance between the fixed contact and the movable contact in the OFF state is set to be sufficiently long taking into account manufacturing tolerances, the size of the electromagnetic relay will be increased.

The present disclosure has been accomplished in view of the above problem.

The above-described electromagnetic relay according to the present disclosure has the position adjustment part formed at the front end of the sleeve. Consequently, it becomes possible to adjust the position of the support part relative to the fixed core. As a result, it becomes possible to adjust an inter-contact distance in the OFF state of the electromagnetic relay; the inter-contact distance is the distance between the fixed contact and the movable contact. In other words, according to the present disclosure, it becomes possible to provide the electromagnetic relay in which the inter-contact distance in the OFF state can be adjusted.

Exemplary embodiments will be described hereinafter with reference to the drawings.

### First Embodiment

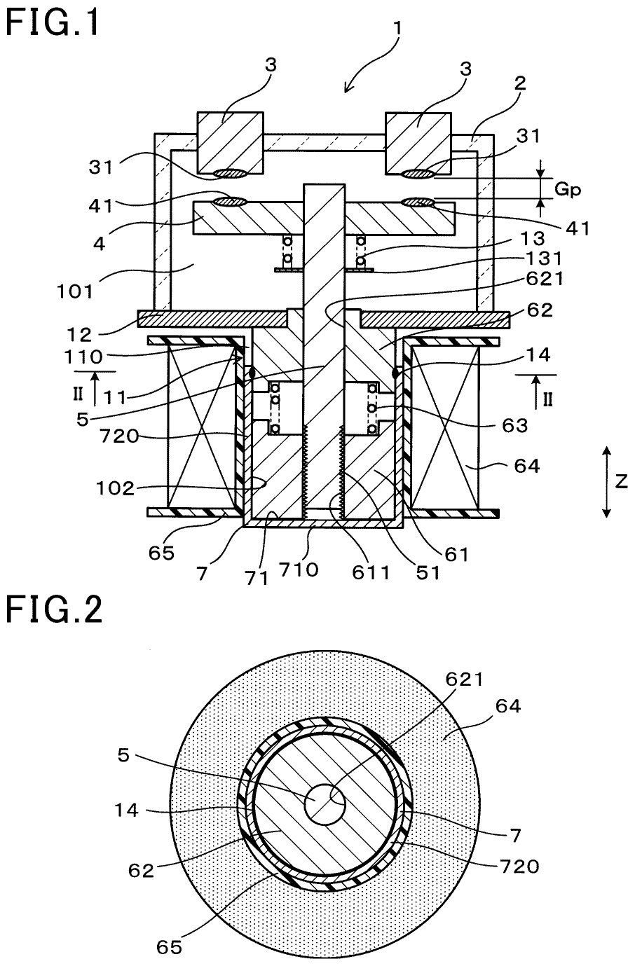

An embodiment relating to an electromagnetic relay will be described with reference to FIGS. 1 to 11. As shown in FIG. 1, an electromagnetic relay 1 according to the present embodiment includes a sealed housing 2, fixed contacts 31, a movable element 4 including movable contacts 41, a shaft 5, a movable core 61, a fixed core 62, a return spring 63, an electromagnetic coil 64, and a sleeve 7.

The fixed contacts 31 are arranged in the sealed housing 2. The movable element 4 includes the movable contacts 41. The movable contacts 41 are provided so as to be respectively brought into contact with and separated from the fixed contacts 31 in the sealed housing 2. The shaft 5 holds the movable element 4, and is provided in such a manner as to be capable of advancing and retreating relative to the sealed housing 2 in an axial direction Z. The movable core 61 is fixed to the shaft 5.

The fixed core 62 is fixed to the sealed housing 2. The return spring 63 urges the movable contacts 41 in a direction away from the fixed contacts 31. When energized, the electromagnetic coil 64 generates magnetic attraction between the fixed core 62 and the movable core 61. The sleeve 7 hermetically seals the return spring 63 and the movable core 61 therein, and is fixed directly or indirectly to the fixed core 62.

The shaft 5 is slidably inserted in a through-hole 621 formed in the fixed core 62. The sleeve 7 has a support part 71. The support portion 71 supports the movable core 61 so as to define the position of the movable core 61 relative to the fixed core 62 when no magnetic attraction acts therebetween.

A position adjustment part 11 is formed at a front end of the sleeve 7. The position adjustment part 11 is a part for adjusting the positional relationship between the fixed core 62 and the support part 71 during the direct or indirect fixing of the sleeve 7 to the fixed core 62. In the present embodiment, the position adjustment part 11 is constituted of an adjustment space 110 which will be described later.

Hereinafter, the advancing/retreating direction of the movable contacts 41 in the electromagnetic relay 1, which coincides with the axial direction of the shaft 5, will be referred to as the Z direction as appropriate. Moreover, in the Z direction, the side where the movable contacts 41 approach the fixed contacts 31 will be referred to as the front side; and the opposite side to the aforementioned side will be referred to as the rear side.

In the present embodiment, the electromagnetic relay 1 has a magnetic plate 12 fixed to a front end of the fixed core 62. A hermetic seal is formed by welding between the magnetic plate 12 and the fixed core 62. The magnetic plate 12 has its major surfaces facing in the Z direction, and is provided so as to extend to the outer peripheral side beyond the fixed core 62. A rear end of the sealed housing 2 is fixed to the magnetic plate 12. The fixed contacts 31 and the movable contacts 41 are arranged in a space surrounded by the sealed housing 2 and the magnetic plate 12. Hereinafter, this space will be referred to as the contact arrangement space 101 as appropriate.

The rear end of the sealed housing 2 is fixed to the magnetic plate 12 with a hermetic seal formed between the sealed housing 2 and the magnetic plate 12 over the entire periphery. The sealed housing 2 may be formed of, for example, ceramic. On the other hand, the magnetic plate 12 may be formed of, for example, a steel plate. Between the sealed housing 2 and the magnetic plate 12, there is arranged an intervening member such as an iron plate (not shown). The intervening member has a coefficient of linear expansion between those of the magnetic plate 12 and the sealed housing 2. The intervening member is welded to the magnetic plate 12 and brazed to the sealed housing 2, thereby fixing the sealed housing 2 and the magnetic plate 12 together while securing the hermetic seal therebetween.

The fixed contacts 31 are provided on busbars 3 that are fixed to part of the sealed housing 2. More particularly, in the present embodiment, to the sealed housing 2, there are fixed two busbars 3 that are electrically insulated from each other. Moreover, on the two busbars 3, there are respectively provided two fixed contacts 31. The two fixed contacts 31 face backward in the Z direction. In addition, hermetic seals are formed by brazing between the busbars 3 and the sealed housing 2.

Furthermore, in the present embodiment, two movable contacts 41 are arranged so as to respectively face the two fixed contacts 31 from the rear side in the Z direction. Both the fixed contacts 31 are provided on the front side of the single movable element 4. The movable element 4 may be formed of, for example, a metal plate. The movable element 4 has the shaft 5 inserted in a part thereof between the two movable contacts 41. The shaft 5 and the movable element 4 are provided so as to be slidable relative to each other in the Z direction. Between the shaft 5 and the movable element 4, there is provided a contact pressure spring 13 to elastically support both the shaft 5 and the movable element 4 in the Z direction. A rear end of the contact pressure spring 13 abuts against a support member 131 that is fixed to the shaft 5. On the other hand, a front end of the contact pressure spring 13 abuts against a rear surface of the movable element 4.

On the rear side of the magnetic plate 12, there is arranged the electromagnetic coil 64 that is wound around an electrically-insulative bobbin 65. Moreover, on the inner peripheral side of the electromagnetic coil 64, there are arranged the fixed core 62 and the movable core 61. The return spring 63 is arranged between the fixed core 62 and the movable core 61 in the Z direction. More specifically, the return spring 63, which is constituted of a coil spring, is arranged between the fixed core 62 and the movable core 61 in an elastically compressed state.

The sleeve 7 covers both a rear end surface and an outer circumferential surface of the movable core 61, and is fixed to an outer circumferential surface of the fixed core 62. The outer circumferential surface of the fixed core 62 is a surface which is parallel to the advancing/retreating direction Z of the movable core 61. The sleeve 7 is joined to the outer circumferential surface of the fixed core 62. The sleeve 7 has a rear wall 710 and a tubular side wall 720 extending forward from an outer periphery of the rear wall 710. That is, the sleeve 7 has a bottomed tubular shape. In addition, the material of the sleeve 7 is not particularly limited, and may be, for example, stainless steel.

As shown in FIG. 2, the gap between an inner circumferential surface of the sleeve 7 and the outer circumferential surface of the fixed core 62 is sealed over the entire circumference. For example, the inner circumferential surface of the sleeve 7 and the outer circumferential surface of the fixed core 62 may be welded together over the entire circumference. It should be noted that in FIGS. 1 and 2, the reference numeral 14 designates the weld between the inner circumferential surface of the sleeve 7 and the outer circumferential surface of the fixed core 62.

Consequently, the movable core 61 and the return spring 63 are hermetically sealed in the space surrounded by the sleeve 7 and the fixed core 62 (hereinafter, to be referred to as the core arrangement space 102 as appropriate). On the other hand, there is a slight gap between the through-hole 621 of the fixed core 62 and an outer circumferential surface of the shaft 5. Therefore, the core arrangement space 102 and the contact arrangement space 101 communicate with each other through this gap. However, both the core arrangement space 102 and the contact arrangement space 101 are hermetically sealed from the external space. Moreover, a gas, such as hydrogen, is hermetically sealed in the contact arrangement space 101.

The rear wall 710 of the sleeve 7 supports a rear surface of the movable core 61. That is, in the present embodiment, the rear wall 710 corresponds to the support part 71. As shown in FIG. 1, the rear wall 710, which constitutes the support part 71, supports the movable core 61 so as to define the position of the movable core 61 relative to the fixed core 62 when no magnetic attraction acts between the fixed core 62 and the movable core 61. In the movable core 61, there is formed a threaded hole 611. On the other hand, on a rear end part of the shaft 5, there is formed a male threaded part 51 that is screwed into the threaded hole 611 of the movable core 61.

On the front side of a front end of the sleeve 7, there is a space 110 adjacent to the front end of the sleeve 7. Hereinafter, this space will be referred to as the adjustment space 110 as appropriate. That is, the front end of the sleeve 7 does not abut against the magnetic plate 12; and the space adjacent to the front end of the sleeve 7 in the Z direction constitutes the adjustment space 110. In the present embodiment, this structural part, i.e., the structural part where the adjustment space 110 is adjacent to and on the front side of the front end of the sleeve 7 corresponds to the position adjustment part 11 described above. The position adjustment part 11 will be described in more detail in the explanation of a manufacturing method of the electromagnetic relay 1 according to the present embodiment which will be given later.

Next, operation of the electromagnetic relay 1 according to the present embodiment will be described with reference to FIGS. 1, 3 and 4.

When the electromagnetic coil 64 is not energized, no magnetic attraction is generated between the fixed core 62 and the movable core 61. Therefore, as shown in FIG. 1, by the urging force of the return spring 63, the movable core 61 is pressed in the direction away from the fixed core 62, i.e., pressed backward. Consequently, the movable element 4 mounted to the movable core 61 via the shaft 5 is in a state of being retreated backward; thus, the movable contacts 41 are in a state of being separated from the fixed contacts 31. Moreover, the movable core 61 is in a state of being supported by the support part 71 of the sleeve 7. Hence, the distances between the fixed contacts 31 and the movable contacts 41 (i.e., the inter-contact distances) become a predetermined size Gp. The size Gp of the inter-contact distances in the OFF state of the electromagnetic relay 1 is set to a size with which it is possible to sufficiently realize arc extinguishing.

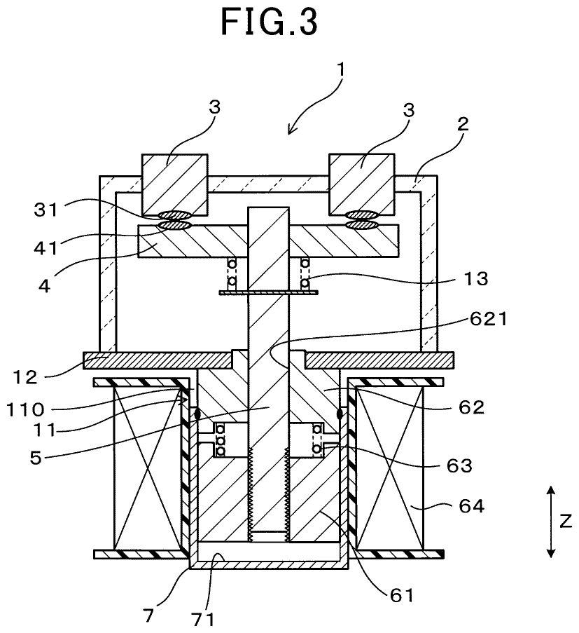

When the electromagnetic coil 64 is energized, magnetic attraction is generated between the fixed core 62 and the movable core 61. Consequently, as shown in FIG. 3, by the magnetic attraction, the movable core 61 is advanced against the restoring force of the return spring 63; thus, the shaft 5 and the movable element 4 are also advanced. As a result, the movable contacts 41 are respectively brought into contact with the fixed contacts 31. In addition, FIG. 3 shows the state of the movable contacts 41 at the moment of being respectively brought into contact with the fixed contacts 31 and thus the state of the contact pressure between the fixed contacts 31 and the movable contacts 41 being substantially zero.

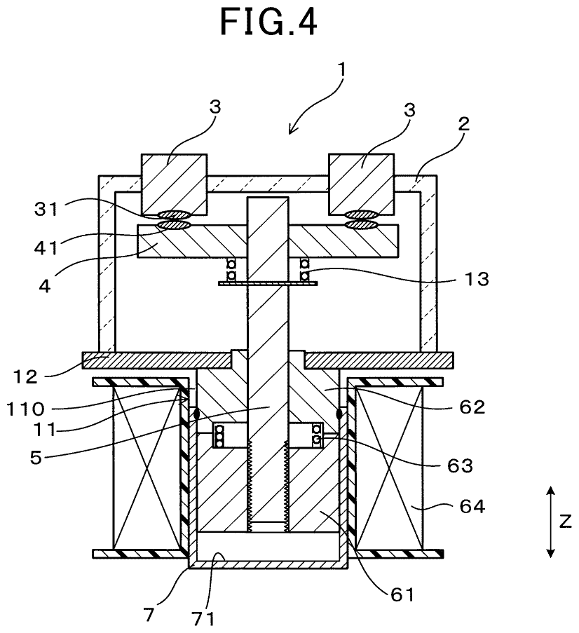

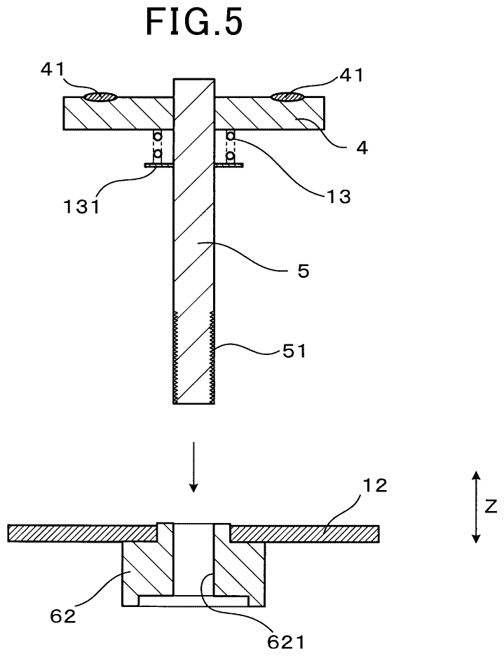

Moreover, from the state shown in FIG. 3, the movable core 61 is further advanced by the magnetic attraction as shown in FIG. 4. More particularly, in the present embodiment, the movable core 61 is advanced until part of the movable core 61 is brought into contact with part of the fixed core 62. At this time, the shaft 5 fixed to the movable core 61 advances, whereas the movable element 4 does advance due to the movable contacts 41 being respectively in contact with the fixed contacts 31. Thus, the shaft 5 advances also relative to the movable element 4, causing the contact pressure spring 13 to be compressed and deformed. Consequently, the elastic force of the contact pressure spring 13 contributes to the contact pressure between the fixed contacts 31 and the movable contacts 41.

From the state shown in FIG. 4, the electromagnetic coil 64 is deenergized, causing the magnetic attraction between the fixed core 62 and the movable core 61 to disappear. Consequently, the movable core 61 is retreated by the restoring force of the return spring 63; then, after the contact pressure decreases to zero, the movable contacts 41 are respectively separated from the fixed contacts 31. Thereafter, the movable core 61 is further retreated until it is brought into the state shown in FIG. 1, i.e., into the state of being supported by the support part 71 of the sleeve 7. As a result, the movable contacts 41 become stationary upon the gaps between the fixed contacts 31 and the movable contacts 41 (i.e., the inter-contact distances) reaching the predetermined size Gp.

Next, the method of manufacturing the electromagnetic relay 1 according to the present embodiment will be described with reference to FIGS. 5 to 11.

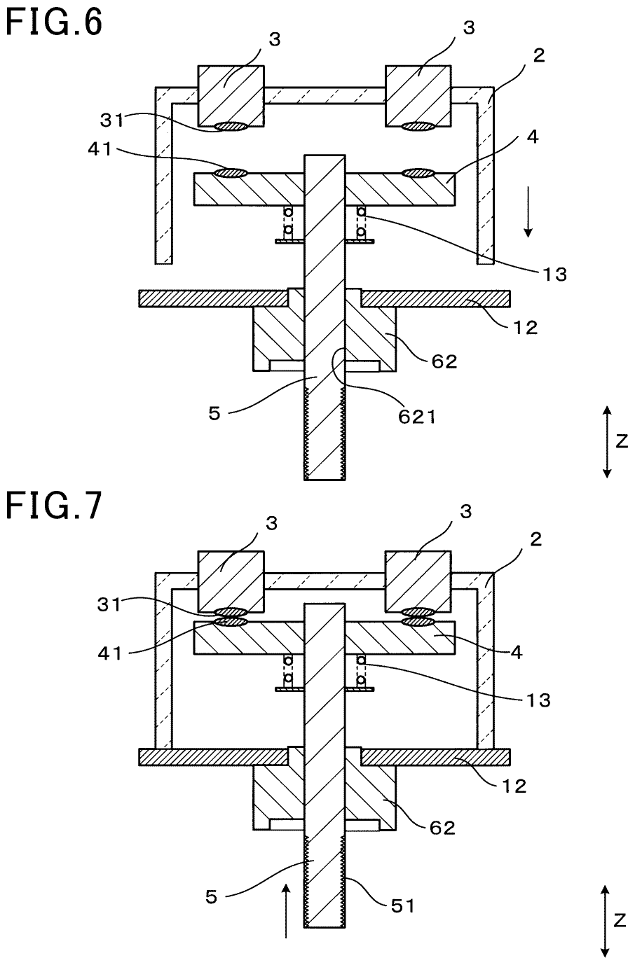

As shown in FIG. 5, a subassembly into which the fixed core 62 and the magnetic plate 12 are integrated, and a subassembly that includes the shaft 5, the movable element 4 and the contact pressure spring 13 are prepared. Next, the shaft 5 is inserted into the through-hole 621 of the fixed core 62. Next, as shown in FIGS. 6 and 7, the sealed housing 2, which has the busbars 3 fixed thereto, is placed to cover front end parts of both the movable element 4 and the shaft 5. Then, the rear end of the sealed housing 2 is joined to the magnetic plate 12.

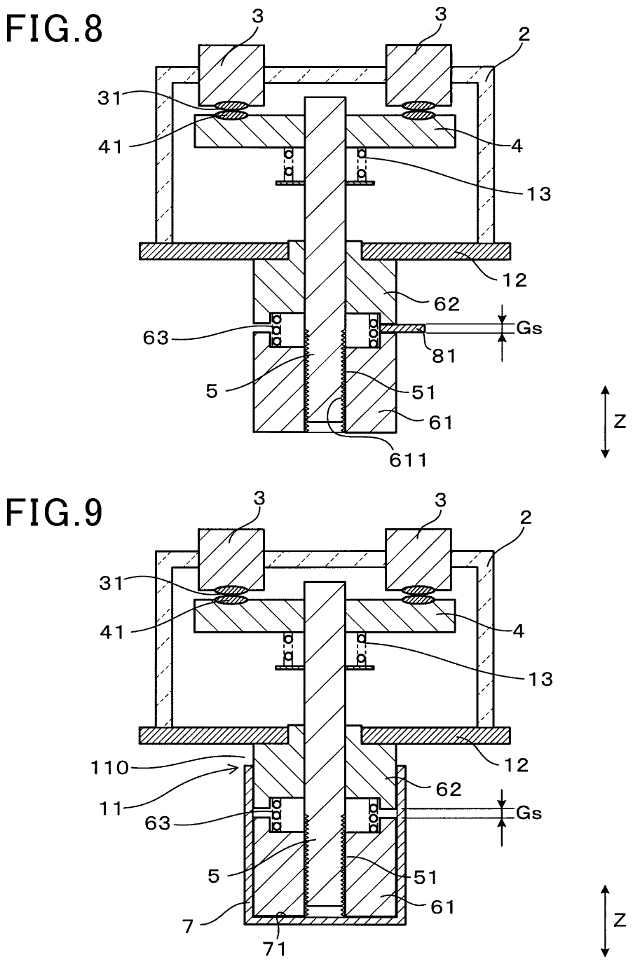

Next, as shown in FIG. 7, the shaft 5 is advanced to bring the movable contacts 41 respectively into contact with the fixed contacts 31. At this time, the contact load between the movable contacts 41 and the fixed contacts 31 is set to be substantially zero. That is, the contact pressure is set to be substantially zero. In this state, the movable core 61 is assembled to the rear end part of the shaft 5 as shown in FIG. 8. More specifically, the male threaded part 51 of the shaft 5 is screwed into the threaded hole 611 of the movable core 61. Then, the position of the movable core 61 relative to the fixed core 62 in the Z direction is adjusted. For example, as shown in FIG. 8, the gap between the fixed core 62 and the movable core 61 in the Z direction (hereinafter, to be referred to as the inter-core distance as appropriate) may be adjusted to a desired size Gs by a gap adjustment gauge 81 sandwiched between the fixed core 62 and the movable core 61.

Next, a rear end part of the threaded hole 611 of the movable core 61 is sealed from the rear side of the threaded hole 611 by brazing or the like; and both the movable core 61 and the fixed core 62 are fixed. In addition, in this state, the size Gs of the inter-core distance is suitably set according to the desired contact pressure. More particularly, in the present embodiment, Gs is set to coincide with the dimension by which the shaft 5 is advanced from the zero contact-pressure state (i.e., the state shown in FIG. 3) when the electromagnetic relay 1 is switched to the ON state (i.e., the state shown in FIG. 4). Moreover, the size Gs also coincides with the amount of compression displacement of the contact pressure spring 12 when the electromagnetic relay 1 is switched to the ON state.

Next, as shown in FIG. 9, the sleeve 7 is placed to cover the movable core 61. At this time, on the front side of the front end of the sleeve 7, there is the adjustment space 110 adjacent to the front end of the sleeve 7. That is, the front end of the sleeve 7 does not abut against the magnetic plate 12. The dimension of the adjustment space 110 in the Z direction is greater than or equal to Gs.

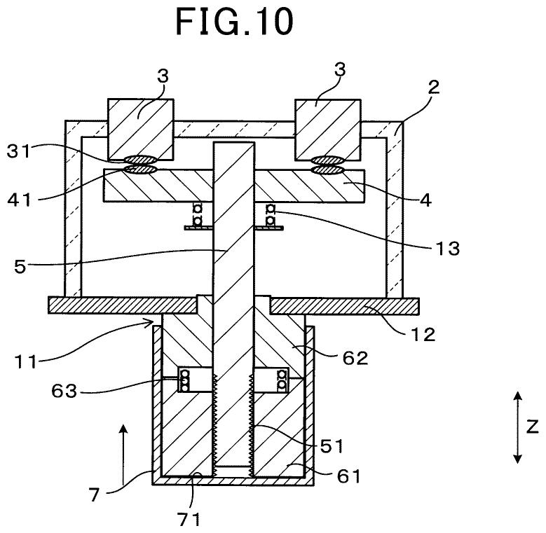

Next, as shown in FIG. 10, the sleeve 7 is pushed forward. Consequently, the movable core 61 and the shaft 5 move forward. More specifically, the sleeve 7 is pushed forward until the movable core 61 is brought into contact with the fixed core 62. That is, the sleeve 7 is pushed forward by the dimension Gs from the state shown in FIG. 9. As a result, contact pressure is applied from the movable contacts 41 to the fixed contacts 31, causing the contact pressure spring 13 to be elastically compressed.

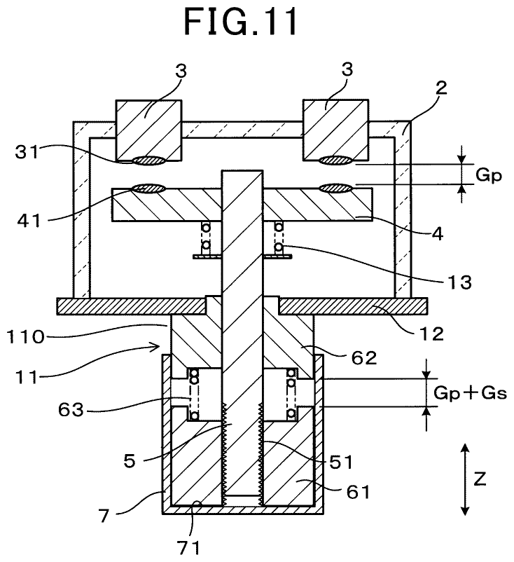

Next, as shown in FIG. 11, the sleeve 7 is retreated. Then, the movable core 61 and the shaft 5 are retreated by the restoring force of the return spring 63. Consequently, the contact pressure between the fixed contacts 31 and the movable contacts 41 is lowered; further, the movable contacts 41 are respectively separated from the fixed contacts 31. Then, the sleeve 7 is further retreated until the gaps between the fixed contacts 31 and the movable contacts 41 reach the predetermined size Gp. That is, the movable core 61 is retreated until the size of the gap between the fixed core 62 and the movable core 61 becomes Gp+Gs. This can be realized by retreating the position of the sleeve 7 relative to the fixed core 62 by the length of Gp+Gs from the state shown in FIG. 10. Then, in the state shown in FIG. 11, the sleeve 7 is fixed to the fixed core 62. For example, a front end part of the sleeve 7 may be welded to the outer circumferential surface of the fixed core 62.

Next, the electromagnetic coil 64 wound around the bobbin 65 is placed on an outer periphery of the sleeve 7. As a result, the electromagnetic relay 1 as shown in FIG. 1 is obtained. In the electromagnetic relay 1, the inter-contact distances in the OFF state are accurately set to the predetermined size Gp.

Next, advantageous effects achievable according to the present embodiment will be described.

In the electromagnetic relay 1, the position adjustment part 11 is formed at the front end of the sleeve 7. Consequently, it becomes possible to adjust the position of the support part 71 relative to the fixed core 62. As a result, it becomes possible to adjust the inter-contact distances in the OFF state; the inter-contact distances are the distances between the fixed contacts 31 and the movable contacts 41 in the Z direction.

Further, by enabling adjustment of the inter-contact distances, it also becomes possible to set the inter-contact distances to a minimum necessary distance for sufficiently realizing arc extinguishing when, for example, the electromagnetic relay 1 is turned off. Consequently, it becomes possible to facilitate reduction in the size of the electromagnetic relay 1.

Moreover, on the front side of the front end of the sleeve 7, there is the adjustment space 110 adjacent to the front end of the sleeve 7. That is, in the present embodiment, the position adjustment part 11 is constituted of the adjustment space 110. Consequently, as described above, it becomes possible to easily adjust the inter-contact distances by sliding the sleeve 7 in the Z direction before fixing the sleeve 7 to the fixed core 62.

Furthermore, the outer circumferential surface of the fixed core 62 is a surface which is parallel to the Z direction. The sleeve 7 is joined to the outer circumferential surface of the fixed core 62. Consequently, it becomes easy to slide the sleeve 7 in the Z direction before fixing the sleeve 7 to the fixed core 62. As a result, it becomes possible to more easily adjust the inter-contact distances.

As described above, according to the present embodiment, it becomes possible to provide the electromagnetic relay 1 in which the inter-contact distances in the OFF state can be adjusted.

### Second Embodiment

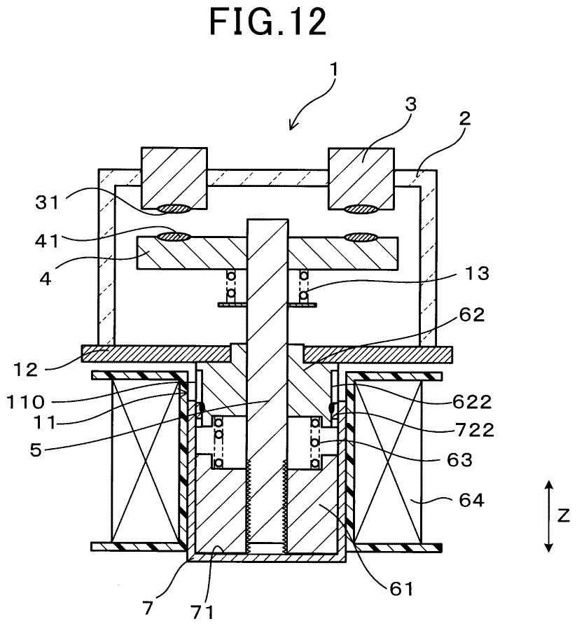

In the present embodiment, as shown in FIGS. 12 to 15, internal protrusions 722 of the sleeve 7 are fitted respectively in longitudinal grooves 622 formed in the outer circumferential surface of the fixed core 62.

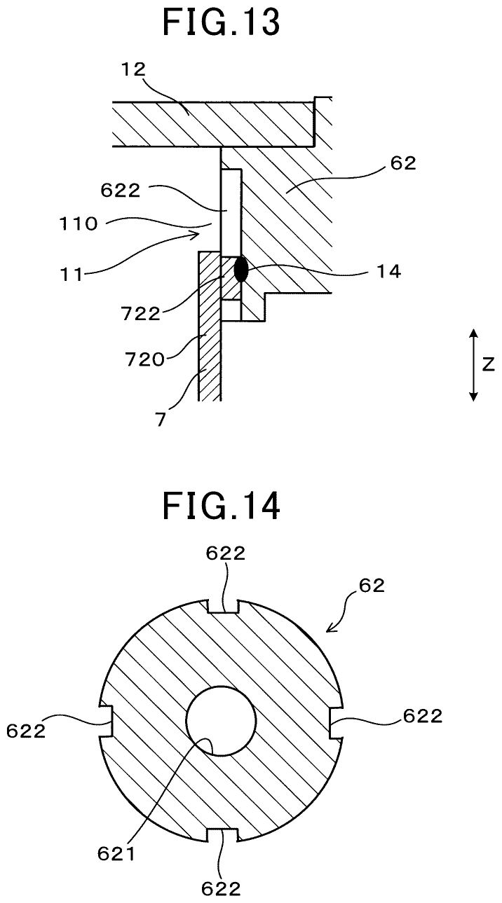

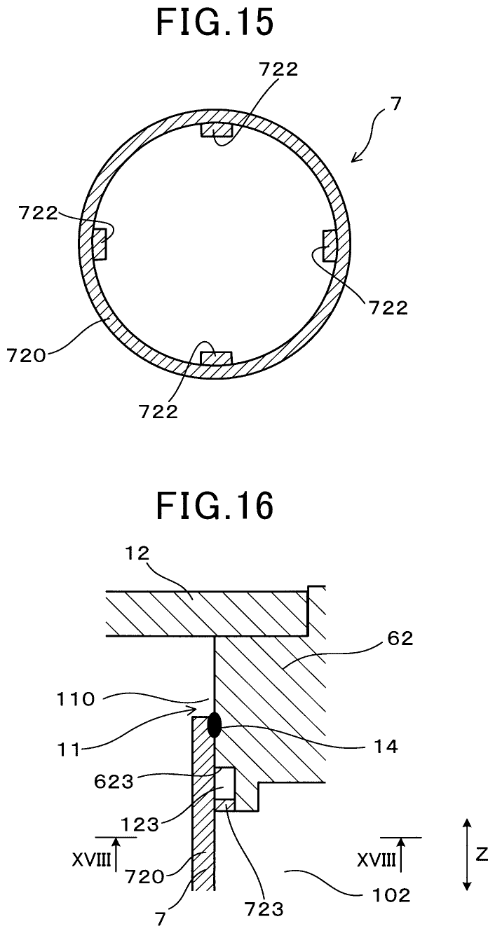

Specifically, in the present embodiment, as shown in FIGS. 13 and 14, in the outer circumferential surface of the fixed core 62, there are formed the longitudinal grooves 622 each extending in the axial direction Z. On the other hand, as shown in FIGS. 13 and 15, the sleeve 7 has the internal protrusions 722 each protruding inward from the side wall 720 in the vicinity of the front end thereof. Moreover, the internal protrusions 722 are arranged respectively in the longitudinal grooves 622.

More particularly, in the present embodiment, as shown in FIG. 14, four longitudinal grooves 622 are formed respectively at four locations in the outer circumferential surface of the fixed core 62. The four longitudinal grooves 622 are formed at substantially equal intervals in the circumferential direction. Moreover, as shown in FIG. 13, the longitudinal grooves 622 are open on the rear side, but closed on the front side. It should be noted that the longitudinal grooves 622 may alternatively be configured to be open on the front side as well.

Moreover, in the present embodiment, as shown in FIG. 15, four internal protrusions 722 are formed respectively at four locations on the inner circumferential surface of the sleeve 7. The four internal protrusions 722 are also formed at substantially equal intervals in the circumferential direction.

The four internal protrusions 722 are fitted respectively in the four longitudinal grooves 622. Moreover, the internal protrusions 722 are joined to the fixed core 62 by welding or the like. It should be noted that the number of the longitudinal grooves 622 and the number of the internal protrusions 722 are not particularly limited, but may alternatively be, for example, three or less, or five or more.

The other features are the same as those in the first embodiment. It should be noted that of the reference signs used in the second and subsequent embodiments, the same reference signs as those used in the previous embodiment(s) designate, unless specified otherwise, the same components as those in the previous embodiment(s). In the present embodiment, in fixing the sleeve 7 to the fixed core 62, the sleeve 7 can be slid against the outer circumferential surface of the fixed core 62 with the internal protrusions 722 fitted respectively in the longitudinal grooves 622. Consequently, it becomes possible to adjust the fixation position of the sleeve 7 while suppressing inclination of the sleeve 7 with respect to the fixed core 62. In addition, according to the present embodiment, it is also possible to achieve the same advantageous effects as achievable according to the first embodiment.

### Third Embodiment

In the present embodiment, as shown in FIGS. 16 to 18, an annular space 123 is formed between a front end surface of a step part 623 of the fixed core 62 and an internal annular part 723 of the sleeve 7.

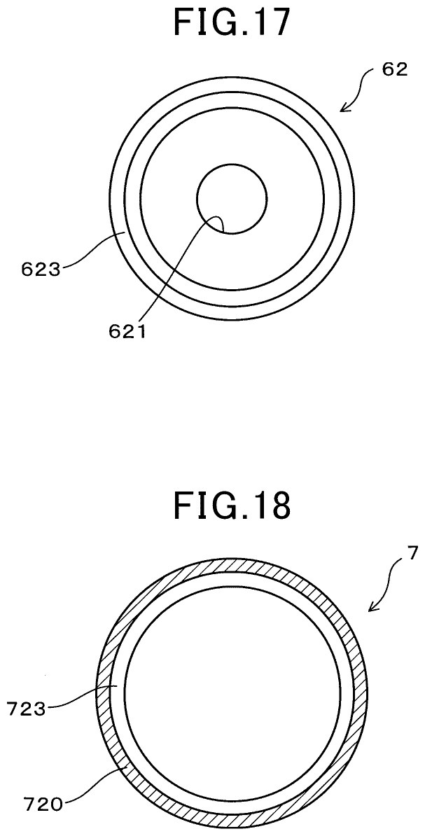

As shown in FIGS. 16 and 17, the fixed core 62 has the step part 623 cut out inward over the entire circumference at a rear end of the outer circumferential surface thereof. On the other hand, as shown in FIGS. 16 and 18, the sleeve 7 has the internal annular part 723 protruding inward from the inner circumferential surface thereof. Moreover, as shown in FIG. 16, the internal annular part 723 is arranged in the step part 623. Consequently, the annular space 123 is formed between the front end surface of the step part 623 and the internal annular part 723. The sleeve 7 is fixed, by welding or the like, to the outer circumferential surface of the fixed core 62 at a location on the front side of the step part 623. The other features are the same as those in the first embodiment.

In the present embodiment, at the rear end of the outer circumferential surface of the fixed core 62, there is formed the annular space 123. Consequently, it becomes possible to retain foreign matter, which may be generated when the sleeve 7 is slid along the outer circumferential surface of the fixed core 62, in the annular space 123. Thus, it becomes possible to prevent the aforementioned foreign matter from intruding into the core arrangement space 102 inside the sleeve 7. Moreover, it also becomes possible to prevent foreign matter, which may be generated during the welding of the sleeve 7 to the fixed core 62, from intruding into the core arrangement space 102. In addition, according to the present embodiment, it is also possible to achieve the same advantageous effects as achievable according to the first embodiment.

It should be noted that the second and third embodiments may be combined with each other. That is, the electromagnetic relay 1 (see FIGS. 12 to 15) according to the second embodiment may be modified to further have a step part 623 and an internal annular part 723 (see FIGS. 16 to 18).

### Fourth Embodiment

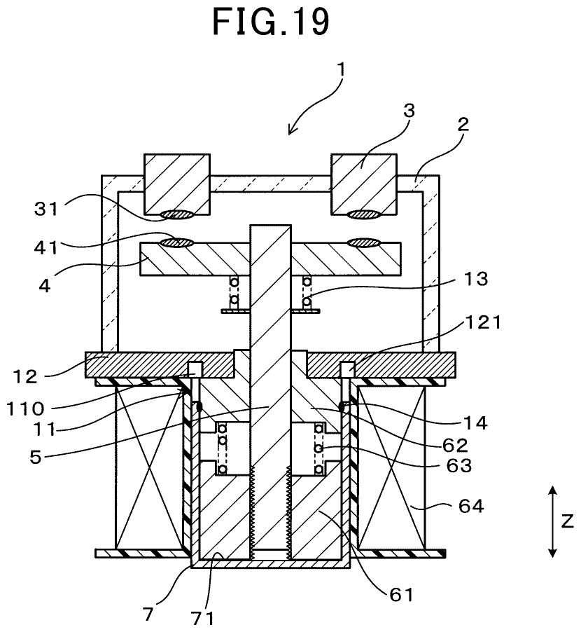

In the present embodiment, as shown in FIGS. 19 to 22, a facing groove 121 is formed in the magnetic plate 12 at a position facing the front end of the sleeve 7. The facing groove 121 is formed in an annular shape at a position on the front side of the front end of the sleeve 7.

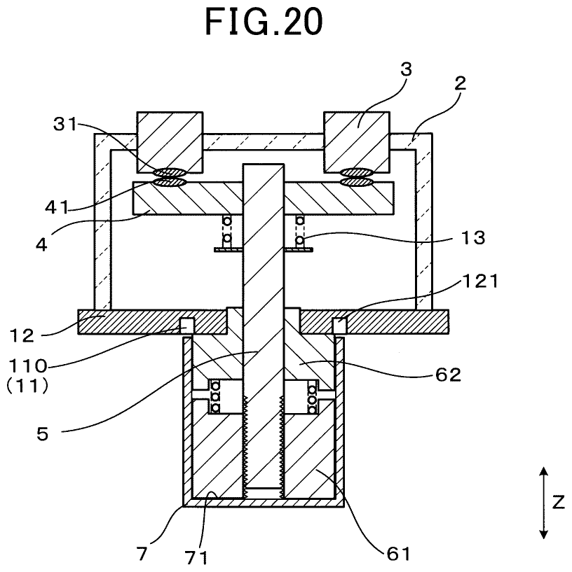

In manufacturing the electromagnetic relay 1, as in the first embodiment (see FIGS. 7 and 8), the contact pressure between the fixed contacts 31 and the movable contacts 41 is set to be substantially zero; and the position of the movable core 61 relative to the fixed core 62 in the Z direction is adjusted. In this state, the movable core 61 and the shaft 5 are fixed to each other; and the sleeve 7 is placed to cover the movable core 61, as shown in FIG. 20. The rear end of the movable core 61 is then supported by the support part 71.

In this state, it is necessary to prevent the front end of the sleeve 7 from interfering with the magnetic plate 12. In other words, the adjustment space 110 is required as the position adjustment part 11. In the present embodiment, as shown in FIG. 20, at least part of the adjustment space 110 is formed of the facing groove 121 provided in the magnetic plate 12. That is, with the facing groove 121, in the state shown in FIG. 20, a sufficient margin is provided as the adjustment space 110 on the front side of the front end of the sleeve 7.

In addition, FIG. 20 illustrates a configuration where in the zero contact-pressure state, the front end of the sleeve 7 is located outside the facing groove 121. It should be noted that an alternative configuration may be employed where in the zero contact-pressure state, the front end of the sleeve 7 is located in the facing groove 121.

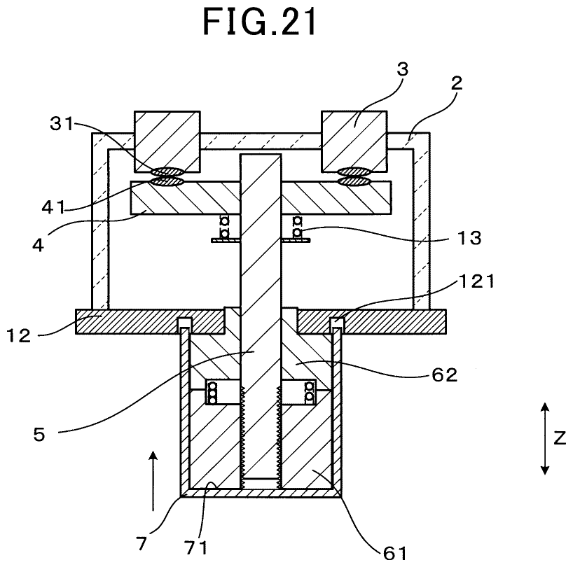

From the state shown in FIG. 20, the sleeve 7 is pushed forward together with the movable core 61 and the shaft 5. Consequently, as shown in FIG. 21, the front end of the sleeve 7 is located in the facing groove 121. In addition, in the present embodiment, the facing groove 121 is formed to have a sufficient depth; thus, the front end of the sleeve 7 is prevented from interfering with the magnetic plate 12.

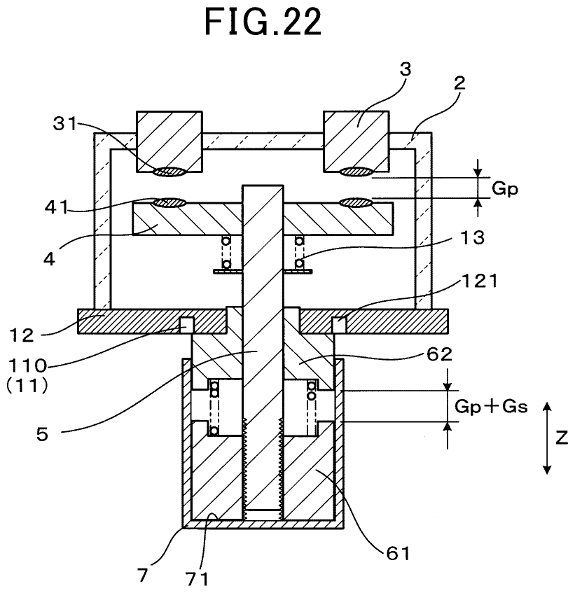

Then, as shown in FIG. 22, the sleeve 7 is retreated until the inter-contact distances reach the predetermined size Gp. That is, the movable core 61 is retreated until the inter-core distance reaches the predetermined size Gp+Gs. In this state, the sleeve 7 and the fixed core 62 are fixed together by welding or the like. The other features are the same as those in the first embodiment.

In the present embodiment, in the case of the magnetic plate 12 having a large thickness, it is easy to form the adjustment space 110 sufficiently. In particular, in the case of the depth of the facing groove 121 being greater than Gp+Gs, it is possible to weld the magnetic plate 12 and a front end part of the sleeve 7 together in the facing groove 121. If the magnetic plate 12 and the sleeve 7 can be joined together to form a hermetic seal therebetween, it will become unnecessary to secure the hermetic seal between the magnetic plate 12 and the fixed core 62. Consequently, it will become possible to simplify the manufacture of the electromagnetic relay 1. In addition, according to the present embodiment, it is also possible to achieve the same advantageous effects as achievable according to the first embodiment.

### Fifth Embodiment

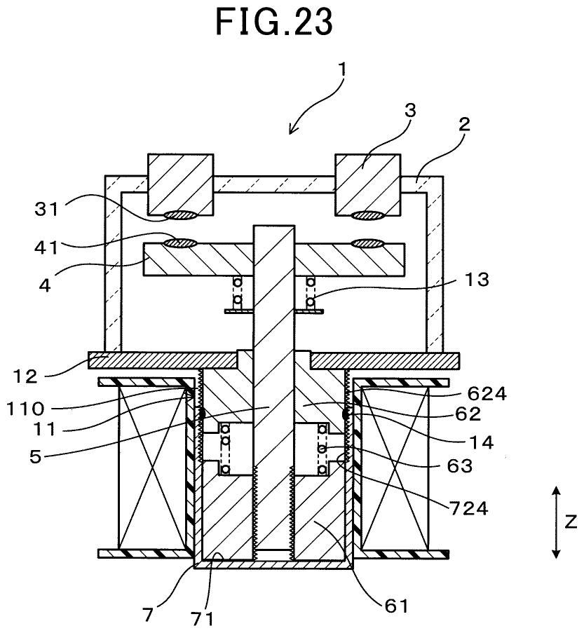

In the present embodiment, as shown in FIGS. 23 to 27, the fixed core 62 and the sleeve 7 are screwed together. Specifically, a male threaded part 624 is formed on the outer circumferential surface of the fixed core 62, whereas a female threaded part 724 is formed on the inner circumferential surface of the sleeve 7.

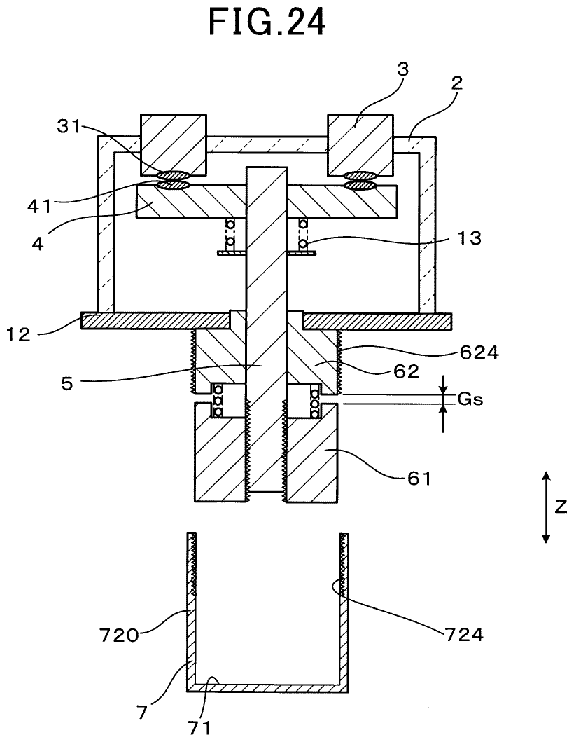

In manufacturing the electromagnetic relay 1, as in the first embodiment (see FIGS. 7 and 8), the contact pressure between the fixed contacts 31 and the movable contacts 41 is set to be substantially zero; and the position of the movable core 61 relative to the fixed core 62 in the Z direction is adjusted. In this state, i.e., in the state shown in FIG. 24, the movable core 61 and the shaft 5 are fixed to each other; and the sleeve 7 is placed to cover the movable core 61.

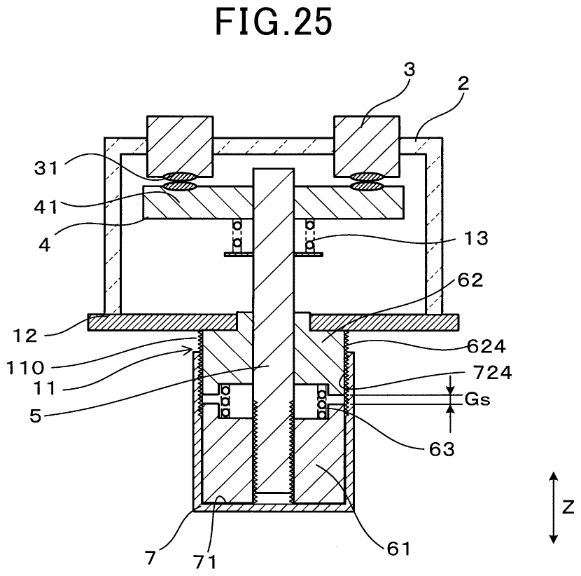

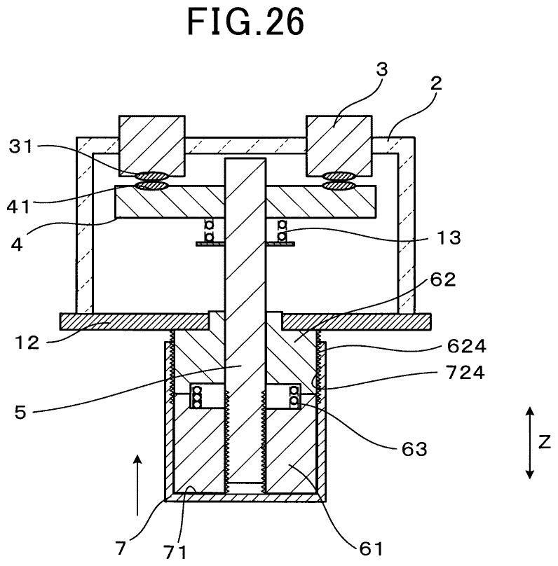

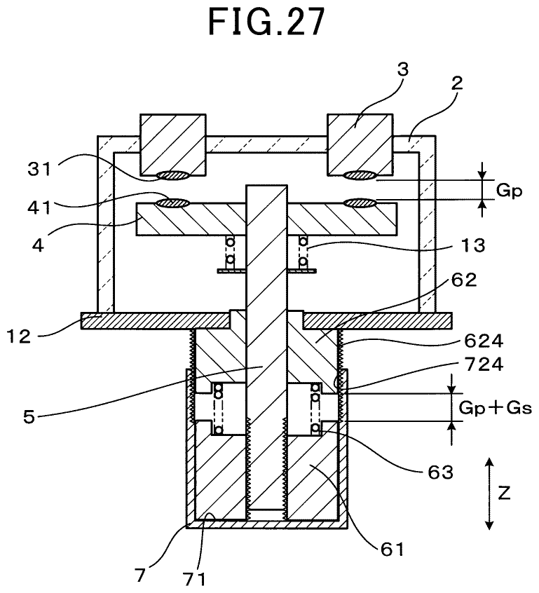

Then, as shown in FIGS. 25 and 26, the sleeve 7, which is screwed onto the fixed core 62, is rotated and thereby advanced, with the support part 71 supporting the rear end of the movable core 61. Specifically, as shown in FIG. 26, the sleeve 7 is rotated and thereby advanced until the fixed core 62 and the movable core 61 are brought into contact with each other. Thereafter, from the state shown in FIG. 26, the sleeve 7 is reversely rotated and thereby retreated until the inter-contact distances reach the predetermined size Gp, as shown in FIG. 27. That is, the sleeve 7 is retreated until the gap between the fixed core 62 and the movable core 61 becomes Gp+Gs. Then, in this state, the sleeve 7 and the fixed core 62 are fixed together by welding or the like. The other features are the same as those in the first embodiment.

According to the present embodiment, it becomes possible to easily adjust the relative position between the fixed core 62 and the sleeve 7 in the Z direction by screwing them together. In addition, according to the present embodiment, it is also possible to achieve the same advantageous effects as achievable according to the first embodiment.

### Sixth Embodiment

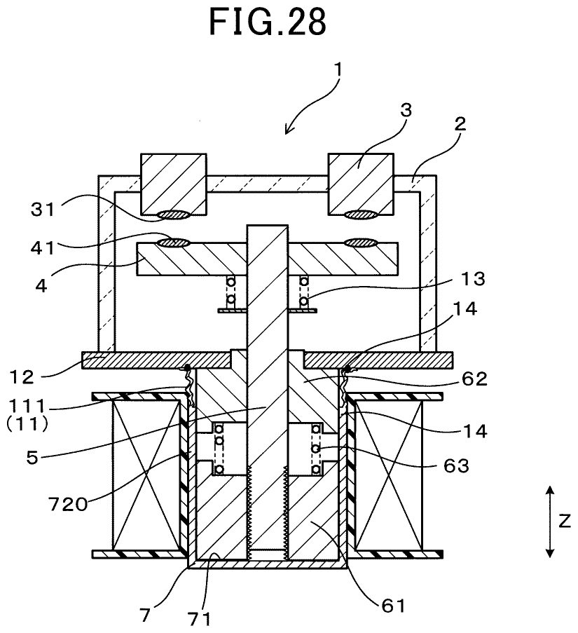

In the present embodiment, as shown in FIGS. 28 to 32, an easily-deformable part 111 is provided at the front end of the sleeve 7. The easily-deformable part 111 is a part of the side wall 720 of the sleeve 7 which is more easily compressively deformable in the Z direction than the other parts of the side wall 720. In addition, the deformation of the easily-deformable part 111 is plastic deformation.

In the present embodiment, the easily-deformable part 111 constitutes the position adjustment part 11. The easily-deformable part 111 is formed by making the thickness of a front end part of the side wall 720 of the sleeve 7 smaller than the thickness of the other parts of the side wall 720.

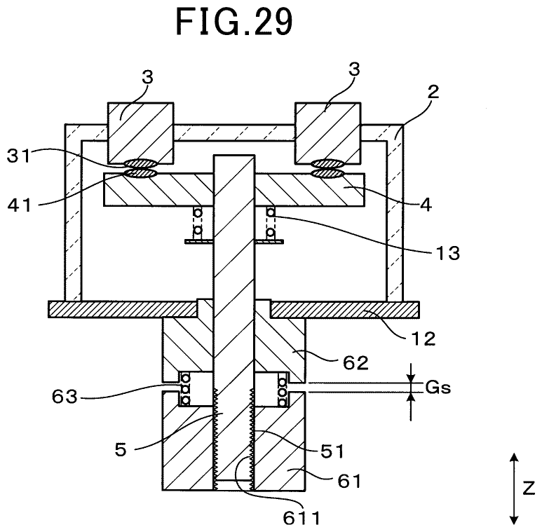

In manufacturing the electromagnetic relay 1, first, as in the first embodiment, as shown in FIG. 29, the movable contacts 41 are respectively brought into contact with the fixed contacts 31 with the contact pressure being zero; and the movable core 61 is assembled to the shaft 5. More specifically, the movable core 61 is assembled to the shaft 5 while adjusting the inter-core distance between the movable core 61 and the fixed core 62 to Gs.

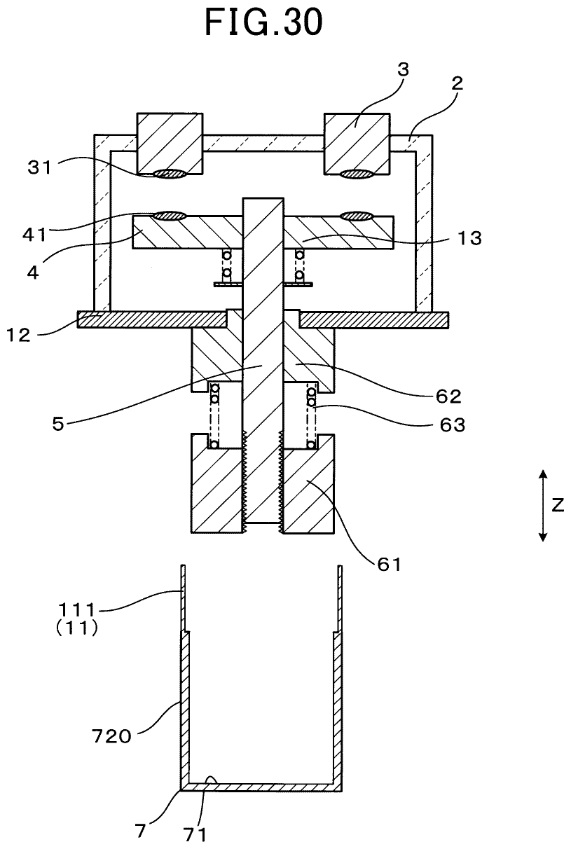

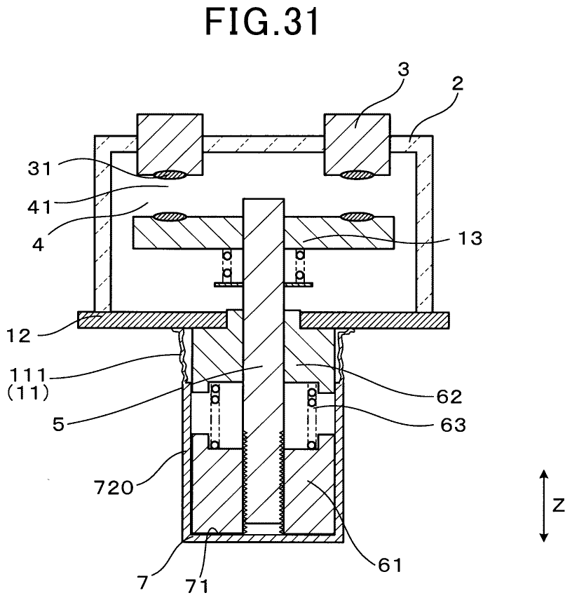

Next, as shown in FIG. 30, the sleeve 7 is placed to cover the movable core 61 from the rear side. At this stage, the sleeve 7 has the easily-deformable part 111 extending parallel to the Z direction. Moreover, at this stage, the movable contacts 41 are respectively separated from the fixed contacts 31; and the inter-core distance between the movable core 61 and the fixed core 62 is greater than Gp+Gs. Then, as shown in FIG. 31, the sleeve 7 is advanced with the movable core 61 being supported by the support part 71. At this time, after the easily-deformable part 111 of the sleeve 7 is brought into contact with the magnetic plate 12, the sleeve 7 is forcibly advanced. Consequently, as shown in FIG. 31, the easily-deformable part 111 is plastically deformed.

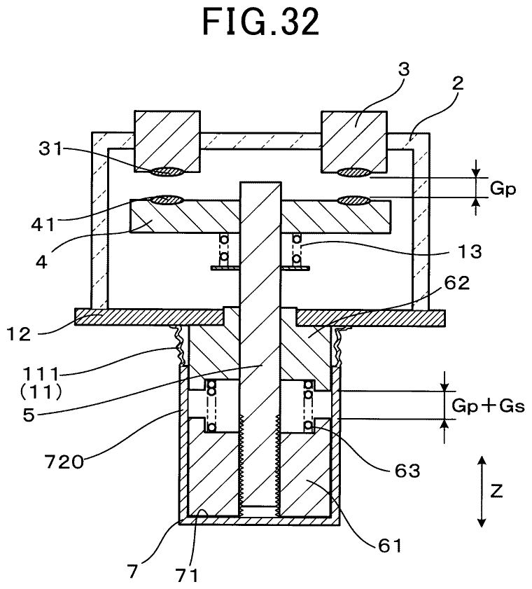

Thereafter, as shown in FIG. 32, the sleeve 7 is further advanced together with the movable core 61 until the inter-contact distances become Gp. Here, the inter-contact distances may be measured by directly observing the distances between the fixed contacts 31 and the movable contacts 41 using X-rays or the like. Alternatively, a method may be employed in which: the gap between the fixed core 62 and the movable core 61 is observed using X-rays or the like; and the sleeve 7 is advanced until the gap becomes Gp+Gs.

Then, in this state, that part of the sleeve 7 which is in contact with the magnetic plate 12 is fixed to the magnetic plate 12 by welding or the like (see FIG. 28). It should be noted that the easily-deformable part 111 may alternatively be formed by various methods other than the method of reducing the thickness. For example, the easily-deformable part 111 may alternatively be formed to have, before being plastically deformed, a shape that is easily compressively deformable in the Z direction, such as a corrugated shape. The other features are the same as those in the first embodiment.

According to the present embodiment, it becomes possible to weld the front end of the sleeve 7 to the magnetic plate 12 over the entire circumference, thereby forming a hermetic seal therebetween. Consequently, it becomes unnecessary to secure the hermetic seal between the magnetic plate 12 and the fixed core 62. As a result, it becomes possible to simplify the manufacture of the electromagnetic relay 1. In addition, according to the present embodiment, it is also possible to achieve the same advantageous effects as achievable according to the first embodiment.

In the first, fourth and fifth embodiments, it is possible to perform the adjustment of the inter-contact distances during the manufacture of the electromagnetic relay 1 while monitoring the inter-contact distances or the inter-core distance using X-rays or the like, as in the sixth embodiment. In this case, it will become unnecessary to perform, after placing the sleeve 7 to cover the movable core 61, the process of advancing the sleeve 7 together with the movable core 61 and the shaft 5 so as to apply contact pressure between the fixed contacts 31 and the movable contacts 41 (i.e., the process shown in FIG. 10 and the like). Specifically, in this case, the inter-contact distances can be adjusted to a desired value by retreating the sleeve 7, from the zero contact-pressure state (i.e., the state shown in FIG. 9 and the like), while monitoring the inter-contact distances or the inter-core distance using X-rays or the like until these distances reach predetermined values.

Moreover, in the above-described embodiments, the fixed core 62 and the magnetic plate 12 are configured as separate members. Alternatively, it is possible to employ a single part into which both the fixed core 62 and the magnetic plate 12 are integrated.

The present disclosure is not limited to the above-described embodiments, but may be applied to various embodiments without departing from the gist of the present disclosure.

Moreover, while the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. An electromagnetic relay comprising:
a sealed housing;
a fixed contact arranged in the sealed housing;
a movable element having a movable contact configured to be brought into contact with and separated from the fixed contact in the sealed housing;
a shaft holding the movable element and provided in such a manner as to be capable of advancing and retreating in an axial direction relative to the sealed housing;
a movable core fixed to the shaft;
a fixed core fixed to the sealed housing;
a return spring urging the movable contact in a direction away from the fixed contact;
an electromagnetic coil configured to generate, when energized, magnetic attraction between the fixed core and the movable core; and
a sleeve hermetically sealing the return spring and the movable core therein and fixed directly or indirectly to the fixed core,
wherein
the shaft is slidably inserted in a through-hole formed in the fixed core,
the sleeve has a support part supporting the movable core so as to define a position of the movable core relative to the fixed core when the magnetic attraction does not act; and
at a front end of the sleeve, there is formed a position adjustment part for adjusting a positional relationship between the fixed core and the support part during the direct or indirect fixing of the sleeve to the fixed core.

2. The electromagnetic relay as set forth in claim 1, wherein
on a front side of the front end of the sleeve, there is a space adjacent to the front end of the sleeve.

3. The electromagnetic relay as set forth in claim 2, wherein
the fixed core has an outer circumferential surface parallel to an advancing/retreating direction of the movable core, and
the sleeve is joined to the outer circumferential surface of the fixed core.

4. The electromagnetic relay as set forth in claim 3, wherein
in the outer circumferential surface of the fixed core, there is formed a longitudinal groove that extends in the axial direction,
the sleeve has an internal protrusion that protrudes inward, and
the internal protrusion is arranged in the longitudinal groove.

5. The electromagnetic relay as set forth in claim 3, wherein
the fixed core has a step part cut out inward over an entire circumference at a rear end of the outer circumferential surface thereof,
the sleeve has an internal annular part protruding inward from an inner circumferential surface thereof,
the internal annular part is arranged in the step part, and
an annular space is formed between a front end surface of the step part and the internal annular part.
